(19) United States
(12) Patent Application Publication
(10) Pub. No.: US 2014/0218331 A1
(43) Pub. Date: Aug. 7, 2014

(54) DYNAMIC POWER ADJUSTMENT OF LEVEL SHIFT FOR NOISE REJECTION IN CAPACITANCE TOUCH SYSTEM

(71) Applicant: AU OPTRONICS CORPORATION, Hsinchu (TW)

(72) Inventors: Jen-Chun Chang, Hsinchu (TW); Yung-Chih Wu, Hsinchu (TW); Hsin-Te Lee, Hsinchu (TW); Chih-Hsiang Yang, Hsinchu (TW)

(73) Assignee: AU OPTRONICS CORPORATION, Hsinchu (TW)

(21) Appl. No.: 13/761,517

(22) Filed: Feb. 7, 2013

(51) Int. Cl. G06F 3/044

(52) U.S. Cl. CPC G06F 3/044
USPC 345/174

(57) ABSTRACT

A dynamic power adjustment circuit for noise rejection in a capacitance touch system includes: a power source configured to generate a fixed power voltage V, a voltage adjustment circuit electrically connected to the power source, and a noise detection circuit electrically connected to the voltage adjustment circuit. The voltage adjustment circuit is configured to generate a plurality of different voltage signals VH(1), VH(2), . . . , VH(n) from the power voltage V, to select one of the voltage signals VH(1), VH(2), . . . , VH(n) as an adjusting voltage VH according to a noise selection signal VH_SEL, and to output the adjusting voltage VH to a level shift for adjusting a driving voltage. The noise detection circuit is configured to generate the noise selection signal VH_SEL for the voltage adjustment circuit according to a plurality of sensing signals RX generated by a capacitance touch sensing device of the capacitance touch system.

### TECHNICAL FIELD

The invention relates generally to touch sensing technology, and more particularly to methods and systems that utilize dynamic power adjustment of level shift for noise rejection in a capacitance touch system of a touch display.

### BACKGROUND

A touch display device usually includes a touch sensing device and a liquid crystal display (LCD) device, where the display device is controlled by a display driving integrated circuit (DDIC), and the touch sensing device is controlled by a touch sensing device driving integrated circuit (TPIC). For a mutual capacitance type touch sensing device, it typically has a plurality of sensing lines spatially arranged along a row direction and a plurality of scanning lines spatially arranged crossing over the plurality of sensing lines along a column direction, defining a plurality of crossover touch areas in a matrix form. In operation, TPIC acquires sensing signals sensed by the sensing lines when a driving voltage is sequentially provided to each scanning line to performing scanning, and processes the acquired sensing signals to determine whether a touch event occurs in the corresponding crossover touch areas and the coordinates of the touch event if occurred. Generally, when no touch event occurs, the sensing signal generated has a lower voltage. A touch event would change the capacitance of the crossover touch area such that the voltage of the sensing signal becomes greater than or equals to a threshold value. Thus, the TPIC may compare the sensing signals to the threshold value to determine whether the touch event occurs.

However, the touch sensing is very susceptible to interference of noises, which can easily lead to malfunction of the touch sensing. Typical noise sources include driving of the display device, unwanted substances attached to the touch sensing device, or other environmental factors that may generate or alter the sensing signals. To avoid the interference from the noises, an adjusting mechanism is applied to the driving voltage such that the sensing signal generated by the sensing line is augmented. One of the adjusting mechanism is to modulate the driving voltage by a fixed voltage such that the voltage level of the driving voltage is shifted to a higher voltage level. However, the intensity of the noises may vary, and the modulation of the driving voltage by the fixed voltage may not always eliminate the interference from the noises.

Therefore, a heretofore unaddressed need exists in the art to address the aforementioned deficiencies and inadequacies.

### SUMMARY

In one aspect, the invention relates to a dynamic power adjustment circuit for noise rejection in a capacitance touch system. In one embodiment, the dynamic power adjustment circuit includes: a power source configured to generate a fixed power voltage V; a voltage adjustment circuit electrically connected to the power source, configured to generate a plurality of different voltage signals VH(1), VH(2), . . . , VH(n) from the power voltage V, to select one of the voltage signals VH(1), VH(2), . . . , VH(n) as a variable adjusting voltage VH according to a noise selection signal VH_SEL, and to output the adjusting voltage VH to a level shift for adjusting a driving voltage, wherein n is an integer larger than 1; and a noise detection circuit electrically connected to the voltage adjustment circuit, configured to generate the noise selection signal VH_SEL for the voltage adjustment circuit according to a plurality of sensing signals RX generated by a capacitance touch sensing device of the capacitance touch system.

In one embodiment, the voltage adjustment circuit includes: a plurality of resistor dividers parallely connected to the power source, each resistor divider comprising a first resistance R1 and a second resistance R2 connected in series, wherein the first resistance R1 is connected to the power circuit and the second resistance R2 is grounded, defining a node between the first and second resistances, such that each resistor divider divides the power voltage V to generate one of the voltage signals VH(1), VH(2), . . . , VH(n) at the node; and a voltage selector electrically connected to the nodes of the resistor dividers and the noise detection circuit such that the voltage selector receives the voltage signals VH(1), VH(2), . . . , VH(n) and determines one of the voltage signals VH(1), VH(2), . . . , VH(n) as the adjusting voltage VH according to the noise selection signal VH_SEL. In a further embodiment, for each resistor divider, the voltage signal

$$VH ( x ) = \frac{R 2 ( x )}{R 1 ( x ) + R 2 ( x )} \times V ,$$

wherein x is an integer between 1 and n.

In one embodiment, the voltage adjustment circuit comprises a power integrated circuit (IC).

In one embodiment, the noise detection circuit includes: a sensing selector configured to receive the sensing signals RX and select one sensing signal RX for output; an analog-to-digital converter (ADC) configured to convert the output sensing signal RX to a digital value; a comparing circuit comparing the digital value of the sensing signal RX to a threshold value, and storing the digital value as a noise data in a noise array when the digital value is greater than or equals to the threshold value; an average circuit averaging the noise data in the noise array to generate a noise average data when a number of the noise data in the noise array is greater than or equals to a predetermined noise maximum number Noise_MAXNUM; a noise selection circuit configured to generate the noise selection signal VH_SEL by looking up a noise average data of the noise array in a voltage adjustment table.

In another aspect, the invention relates to a driving system for a touch display having a capacitance touch sensing device for sensing a touch event. In one embodiment, the driving system includes: a touch sensing controller configured to output a plurality of driving voltages and to receive a plurality of sensing signals RX from the capacitance touch sensing device, and to determine whether the touch event occurs by comparing each sensing signal RX to a threshold value; a level shift configured to receive the driving voltages and a variable adjusting voltage VH and to send a plurality of scanning signals TX to the touch sensing device, wherein the level shift generates the scanning signals by shifting voltage levels of the driving voltages with the adjusting voltage VH; and a dynamic power adjustment circuit configured to receive the plurality of sensing signals RX from the touch sensing controller, and to generate the adjusting voltage VH according to noise detection of the plurality of sensing signals RX.

In one embodiment, the touch display further comprises a display device for displaying an image characterized with a series of frames. In a further embodiment, the driving system further includes a display driving controller synchronized with the capacitance touch sensing controller. In one embodiment, the display device and the touch sensing device are integrated into a single in-cell touch display panel or stacked up in separate panels.

In one embodiment, The dynamic power adjustment circuit includes: a power source configured to generate a fixed power voltage V; a voltage adjustment circuit electrically connected to the power source, configured to generate a plurality of different voltage signals VH(1), VH(2), . . . , VH(n) from the power voltage V, to select one of the voltage signals VH(1), VH(2), . . . , VH(n) as the adjusting voltage VH according to a noise selection signal VH_SEL, and to output the adjusting voltage VH to the level shift for adjusting the driving voltages, wherein n is an integer larger than 1; and a noise detection circuit electrically connected to the voltage adjustment circuit and the touch sensing controller, configured to receive the plurality of sensing signals RX from the touch sensing controller, and to generate the noise selection signal VH_SEL for the voltage adjustment circuit according to the plurality of sensing signals RX.

Another aspect of the invention relates to a method for driving a touch display for sensing a touch event. In one embodiment, the method includes: receiving a plurality of sensing signals RX from a capacitance touch sensing device of the touch display; generating a variable adjusting voltage VH according to noise detection of the plurality of sensing signals RX; generating a plurality of scanning signals TX according to a plurality of driving voltages and the adjusting voltage VH; and driving the capacitance touch sensing device by the plurality of scanning signals TX.

In one embodiment, the step of generating the plurality of scanning signals TX includes: generating, by a touch sensing controller, the plurality of driving voltages; and adjusting, by a level shift, the plurality of driving voltages by the adjusting voltage VH to generate the plurality of scanning signals TX.

In one embodiment, the step of generating the adjusting voltage includes: generating a plurality of voltage signals VH(1), VH(2), . . . , VH(n) from the power voltage V; generating a noise selection signal VH_SEL according to the plurality of sensing signals RX; and selecting one of the voltage signals VH(1), VH(2), . . . , VH(n) as the adjusting voltage VH according to the noise selection signal VH_SEL. In a further embodiment, each of the plurality of voltage signals VH(1), VH(2), . . . , VH(n) is generated by providing the power voltage V with a plurality of resistor dividers in parallel to one another. Each resistor divider includes a first resistance R1 and a second resistance R2 connected in series, where the first resistance R1 is provided with the power voltage V and the second resistance R2 is grounded, defining a node between the first and second resistances, such that each resistor divider divides the power voltage V to generate one of the voltage signals VH(1), VH(2), . . . , VH(n) at the node. In one embodiment, for each resistor divider, the voltage signal

$$VH ( x ) = \frac{R 2 ( x )}{R 1 ( x ) + R 2 ( x )} \times V ,$$

wherein x is an integer between 1 and n.

In one embodiment, the step of generating the noise selection signal VH_SEL includes: converting each sensing voltage RX to a digital value; comparing the digital value of each sensing voltage RX to a threshold value, and storing the digital value as a noise data in a noise array when the digital value is greater than or equals to the threshold value; averaging the noise data in the noise array to generate a noise average data when a number of the noise data in the noise array is greater than or equals to a predetermined noise maximum number Noise_MAXNUM; and generating the noise selection signal VH_SEL by looking up the noise average data of the noise array in a voltage adjustment table.

These and other aspects of the present invention will become apparent from the following description of the preferred embodiment taken in conjunction with the following drawings, although variations and modifications therein may be effected without departing from the spirit and scope of the novel concepts of the invention.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment, and wherein:

FIG. 1 shows schematically a touch display having a capacitance touch sensing device according to one embodiment of the invention;

FIG. 2A shows schematically an ideal touch determination scheme for a capacitance touch panel according to one embodiment of the invention;

FIG. 2B shows schematically a touch determination scheme for a capacitance touch panel with a noise source according to one embodiment of the invention;

FIG. 3A shows schematically a driving circuit for a touch display according to one embodiment of the invention;

FIG. 3B shows schematically an enhanced touch determination scheme for a capacitance touch panel with a noise source according to one embodiment of the invention;

FIG. 4 shows schematically a driving circuit for a touch display having a dynamic power adjustment circuit according to one embodiment of the invention;

FIG. 5 shows schematically a dynamic power adjustment circuit according to one embodiment of the invention;

FIG. 6A shows schematically a voltage adjustment circuit according to one embodiment of the invention;

FIG. 6B shows schematically a voltage adjustment circuit according to another embodiment of the invention;

FIG. 7 shows schematically a noise detection circuit according to one embodiment of the invention; and

FIG. 8 shows a flowchart of noise detection according to one embodiment of the invention.

### DETAILED DESCRIPTION OF THE INVENTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this invention will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top”, may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper”, depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present invention, and will not be interpreted in an idealized or overly formal sense unless expressly so defined herein.

As used herein, “around”, “about”, “substantially” or “approximately” shall generally mean within 20 percent, preferably within 10 percent, and more preferably within 5 percent of a given value or range. Numerical quantities given herein are approximate, meaning that the term “around”, “about” “substantially” or “approximately” can be inferred if not expressly stated.

The term “vertical synchronization signal” or its acronym “VSYNC”, as used herein, refers to a synchronization signal representing a beginning of each and every frame of a series of frames of an image displayed on a display device.

The term “horizontal synchronization signal” or its acronym “HSYNC”, as used herein, refers to a synchronization signal representing a beginning of line scanning of each and every line of a plurality of scan lines of a display device.

As used herein, the term “display trigger” or “display trigger signal” refers to an enable signal to enable/start display driving or disable/stop display driving.

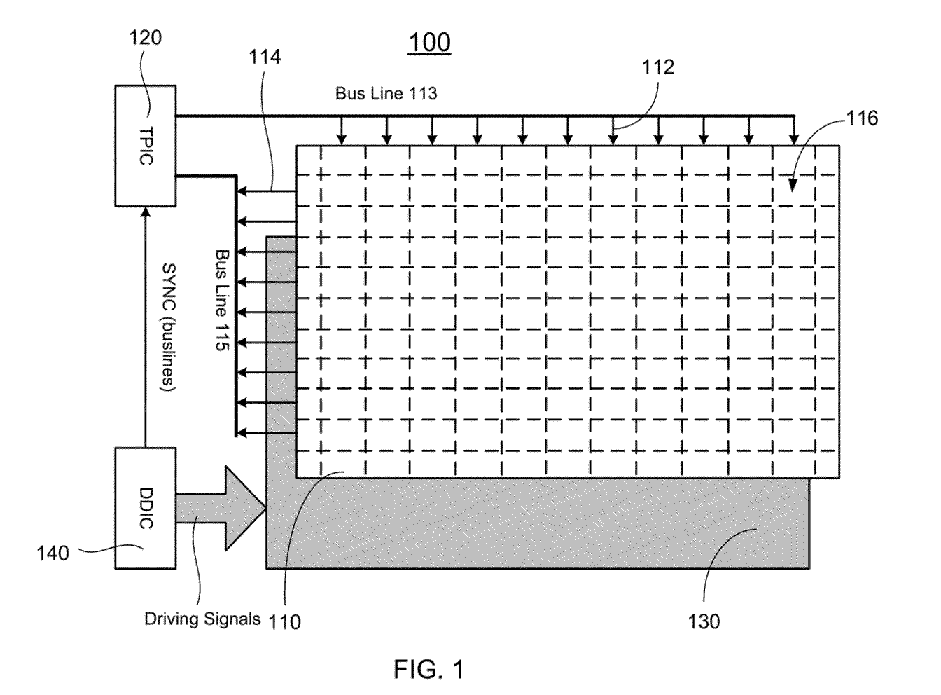

The description will be made as to the embodiments of the present invention in conjunction with the accompanying drawings in FIGS. 1-8. In accordance with the purposes of this invention, as embodied and broadly described herein, this invention, in one aspect, relates to methods and systems that utilize dynamic stop display frame driving mechanisms for touch sensing of a touch display device. The driving methods and systems are particularly adapted for an LCD touch display, where the liquid crystals have response times long enough so that even if the driving of thin film transistors (TFTs) of pixels is stopped/disabled for a while, for example, for one or more frames, the pixels can still hold enough voltage levels as so to keep the image displaying at the same grey level without compromising the display quality. The touch sensing is then performed within the period of the one or more frames when no display driving is performed. It should be appreciated that the invention is not restricted in LCD touch display devices, and any kind of display devices having the characteristic of keeping the image quality for a frame time with stopping display driving can also be utilized to practice the invention.

Referring to FIG. 1, a touch display 100 is schematically shown according to one embodiment of the invention. In the exemplary embodiment, the touch display 100 has a capacitance touch sensing device 110 and a display device 130. The capacitance touch sensing device 110 and the display device 130 can be made in an integrated panel or in two individual panels. The former corresponds to an in-cell touch display device, where the display device and touch sensing device are integrated into one panel instead of stacking up in separate layers. The touch display 100 also includes a driving system having a touch sensing device integrated circuit (TPIC) 120 for driving the capacitance touch sensing device 110 to sense a touch event thereon and a display driving integrated circuit (DDIC) 140 for driving the display device 130 to display an image thereon. In certain embodiments, the display driving controller 140 and the touch sensing controller 120 may be synchronized with each other such that the touch sensing device 100 is driven only when the display device 130 is not driven in selected frames of the series of frames. The TPIC 120 and the DDIC 140 are also known as a touch sensing controller and a display driving controller, respectively. The terms “touch sensing device integrated circuit” or “TPIC”, and “display driving integrated circuit” or “DDIC” are respectively exchangeable with the terms “touch sensing controller” and “display driving controller” in the invention.

The capacitance touch sensing device 110 has a plurality of scanning lines 112 spatially arranged along a column direction and a plurality of sensing lines 114 spatially arranged crossing over the plurality of scanning lines 112 along a row direction, which are electrically coupled to the TPIC 120 through, for example, bus lines 113 and 115, respectively. Thus, a plurality of crossover touch areas 116 is defined in a matrix form, wherein each crossover touch area 116 is electrically connected to a corresponding scanning line and a corresponding sensing line and has a capacitance subject to change when the crossover area is touched. In operation, the TPIC 120 acquires sensing signals sensed by the sensing lines 114 when each scanning line 112 is provided with a scanning signal (the driving voltage) TX to perform scanning, and processes the acquired sensing signals to determine whether a touch event occurs at the corresponding crossover touch area 116 and the coordinates of the crossover touch area 116 where the touch event occurs. The capacitance touch sensing device 110 is also known as the “capacitance touch panel”. In this exemplary embodiment, the term “touch sensing device” is exchangeable with the term “touch panel”.

The display device 130 can be an LCD device or any kind of display devices having the characteristic of keeping the image quality for a frame time with stopping display driving. The display device 130 is driven by driving signals generated by the DDIC 140 to display an image. Generally, the DDIC 140 also provides, among other driving signals, vertical and horizontal synchronization signals SYNC for controlling the display device 130 to display the image in terms of a series of frames. The vertical and horizontal synchronization signals are usually generated from a timing controller (not shown in FIG. 1), which can be integrated in the DDIC 140 or exist as an individual IC. In certain embodiments, vertical and horizontal synchronization signals SYNC are provided from the DDIC 140 to the TPIC 120 through SYNC bus lines for synchronizing the operations of the DDIC 140 and the TPIC 120. The display device 130 is also known as the “display panel”. In this exemplary embodiment, the term “display device” is exchangeable with the term “display panel”.

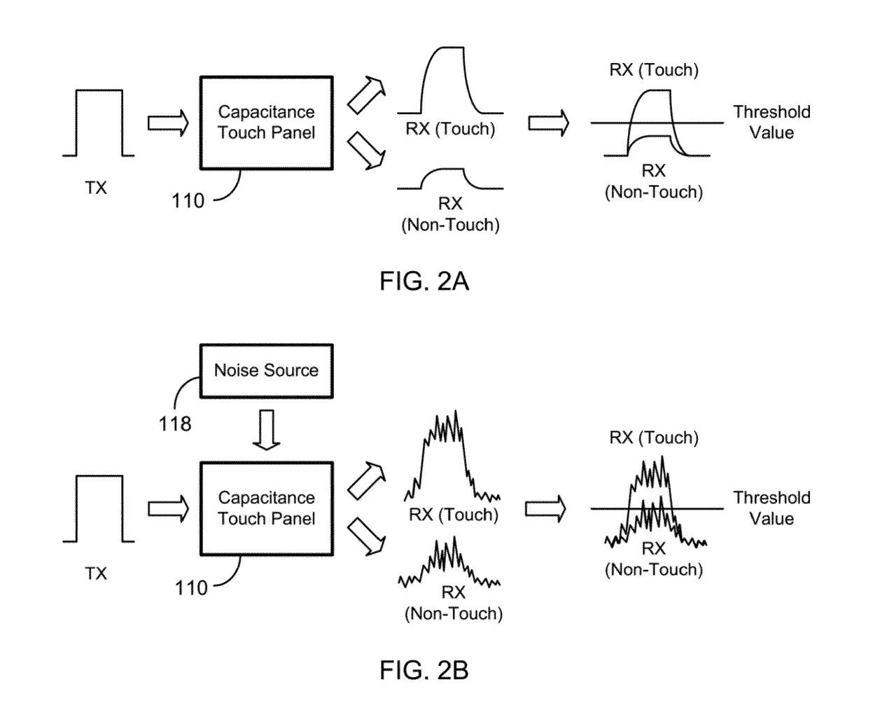

FIG. 2A shows schematically an ideal touch determination scheme for a capacitance touch panel according to one embodiment of the invention. Generally, when a driving voltage is provided as the scanning signal TX to the capacitance touch panel 110 through the scanning line 112, the corresponding crossover touch area 116 to the scanning line 112 has a capacitance, which is subject to change when a touch event occurs thereto. As shown in FIG. 2A, when no touch event occurs, the sensing signal RX generated has a relatively lower voltage. A touch event would change the capacitance of the crossover touch area 116 such that the voltage of the sensing signal RX becomes greater. Thus, when the sensing signal RX is sent to the TPIC 120, the TPIC 120 may compare the sensing signal RX to a preset threshold value to determine whether the touch event occurs. When the sensing signal RX is greater than or equals to the threshold value, the TPIC 120 determines that the touch event has occurred. On the other hand, when the sensing signal RX is less than the threshold value, the TPIC 120 determines that no touch event has occurred.

However, the touch determination scheme may be interfered by the noises. FIG. 2B shows schematically a touch determination scheme for a capacitance touch panel with a noise source according to one embodiment of the invention. As shown in FIG. 2B, when the noise source 118 exists, the sensing signal RX generated may be in an irregular wave form disturbed by the noise. Therefore, the sensing signal RX generated with the interference of the noises may exceed the threshold value even if no touch event has occurred, leading to a misjudgment by the TPIC 120 that a false touch event has occurred. Accordingly, there is a need to apply an adjustment scheme to the driving circuit of the touch display to reduce the interference of the noises.

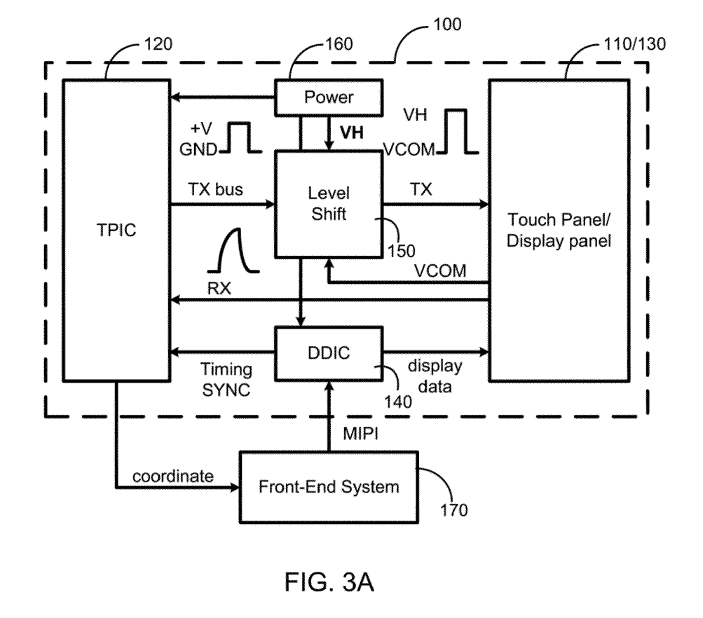

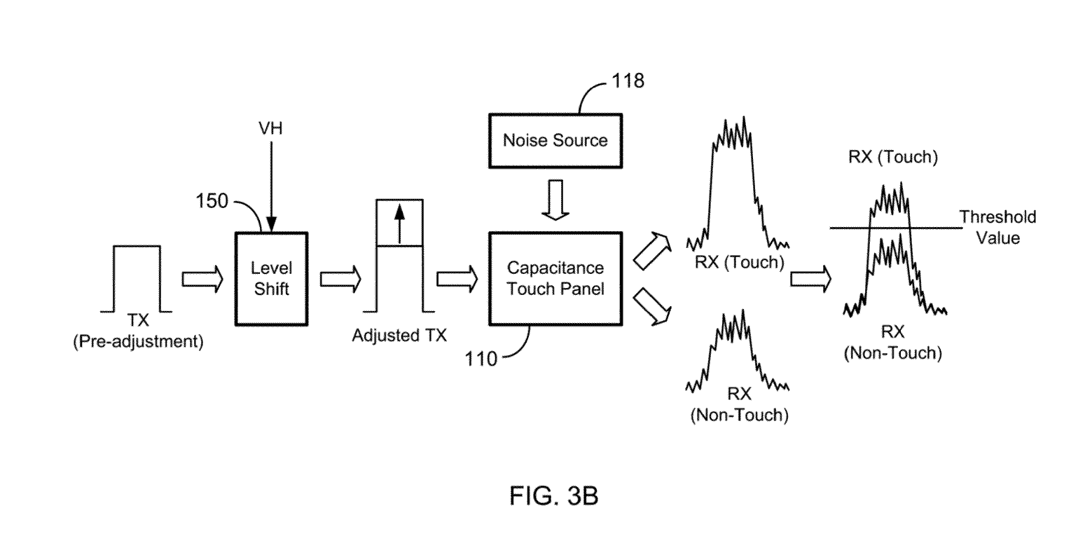

FIG. 3A shows schematically a driving circuit for a touch display according to one embodiment of the invention. As shown in FIG. 3A, the driving circuit 100 includes the capacitance touch panel 110 and the display panel 130, which is made in an integrated panel. The driving circuit 100 also includes the TPIC 120 and the DDIC, which has been described with reference to FIG. 1. Further, the driving circuit 100 includes a level shift 150 between the touch panel 110 and the TPIC 120, and a power source 160 to generate a power voltage VH for other elements, including the level shift 150. A front-end system 170 is provided to receive the coordinates of the touch event, if occurs, such that the front-end system 170 may generate corresponding display information and send the information to the DDIC 140 through a mobile industry processor interface (MIPI).

FIG. 3B shows schematically an enhanced touch determination scheme for a capacitance touch panel with a noise source according to one embodiment of the invention. As shown in FIGS. 3A and 3B, the level shift 150 is provided to shift, or to augment, the voltage level of the driving voltage TX, and a power source 160 is provided to generate the adjusting voltage VH. When the driving voltage TX (the pre-adjustment scanning signal) is provided to the level shift 150, the level shift 150 shifts the pre-adjustment scanning signal TX from the original voltage level to a greater voltage level by the adjusting voltage VH, thus obtaining the adjusted scanning signal TX. Then the level shift 150 sends the adjusted scanning signal TX to the capacitance touch panel 110. Although the existence of the noise source 118 would disturb the sensing signal RX generated, the voltage level of the sensing signal RX would be augmented due to the adjusted voltage level of the adjusted scanning signal TX such that the difference between the sensing signal RX generated under the touch event and the sensing signal RX generated without the touch event is significant. Thus, a new threshold value may be predetermined to differentiate the sensing signal RX generated under the touch event and the sensing signal RX generated without the touch event.

It should be appreciated that the level shift 150 shifts the voltage level of the driving voltage without changing other characteristics of the driving voltage, such as the phase or the wave form of the driving voltage. In other words, the scanning signals TX have the same phase and wave forms as the driving voltages.

Further, the adjusting voltage VH generated by the power source 160 as shown in FIG. 3A is a fixed power voltage, which is not variable in response to different noises. Thus, the adjustment may be optimized to certain types of noises but not to other types of noises. To enable dynamic adjustment to the driving voltage TX, a dynamic power adjustment circuit may be provided to replace the power source 160 as shown in FIG. 3A.

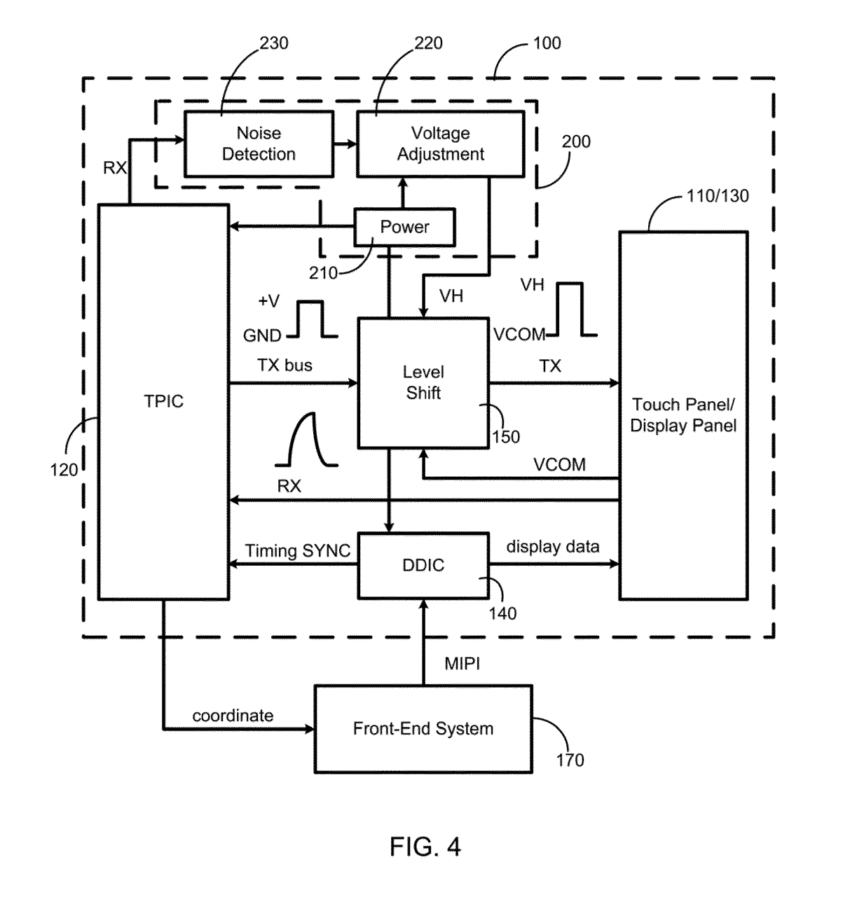

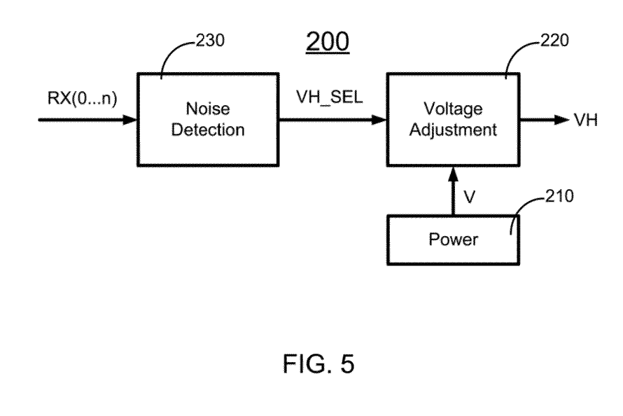

FIG. 4 shows an embodiment of a driving circuit for a touch display having a dynamic power adjustment circuit, and FIG. 5 shows the dynamic power adjustment circuit. As shown in FIG. 4, the dynamic power adjustment circuit 200 is provided to replace the power source 160 as shown in FIG. 3A. Other elements as shown in FIG. 4 are similar to the elements as shown in FIG. 3A, and the detailed description thereof are hereafter omitted.

The dynamic power adjustment circuit 200 is configured to receive the plurality of sensing signals RX from the touch sensing controller 120, and to generate a variable adjusting voltage VH according to noise detection of the plurality of sensing signals RX. As shown in FIGS. 4 and 5, the dynamic power adjustment circuit 200 includes a power source 210, a voltage adjustment circuit 220, and a noise detection circuit 230. The power source 210 is configured to generate a power voltage V, which is a fixed high voltage, for other elements of the driving circuit 100. However, instead of sending the fixed power voltage V directly to the level shift 150 for adjustment, the power voltage V is sent to the voltage adjustment circuit 220 to generate a variable adjusting voltage VH such that dynamic adjustment can be realized.

The voltage adjustment circuit 220 is electrically connected to the power source 210, the noise detection circuit 230 and the level shift 150, configured to receive the fixed power voltage V from the power source 210 and a noise selection signal VH_SEL from the noise detection circuit 230, and to generate a variable adjusting voltage VH for the level shift 150. Specifically, the voltage adjustment circuit 220 generates a plurality of voltage signals VH(1), VH(2), . . . , VH(n) from the power voltage V. Thus, when the voltage adjustment circuit 220 receives a noise selection signal VH_SEL from the noise detection circuit 230, the voltage adjustment circuit 220 may select one of the voltage signals VH(1), VH(2), . . . , VH(n) as the adjusting voltage VH according to the noise selection signal VH_SEL, and then output the adjusting voltage VH to a level shift for adjusting a driving voltage TX.

It should be appreciated that the adjusting voltage VH generated by the voltage adjustment circuit 220 is variable. Thus, the voltage level of the adjusted scanning signals TX by the level shift 150 would be variable, and the threshold value used by the TPIC 120 for determination as to whether the touch event occurs may also change correspondingly. The threshold value used by the TPIC 120 is adjusted in response to the noise selection signal VH_SEL.

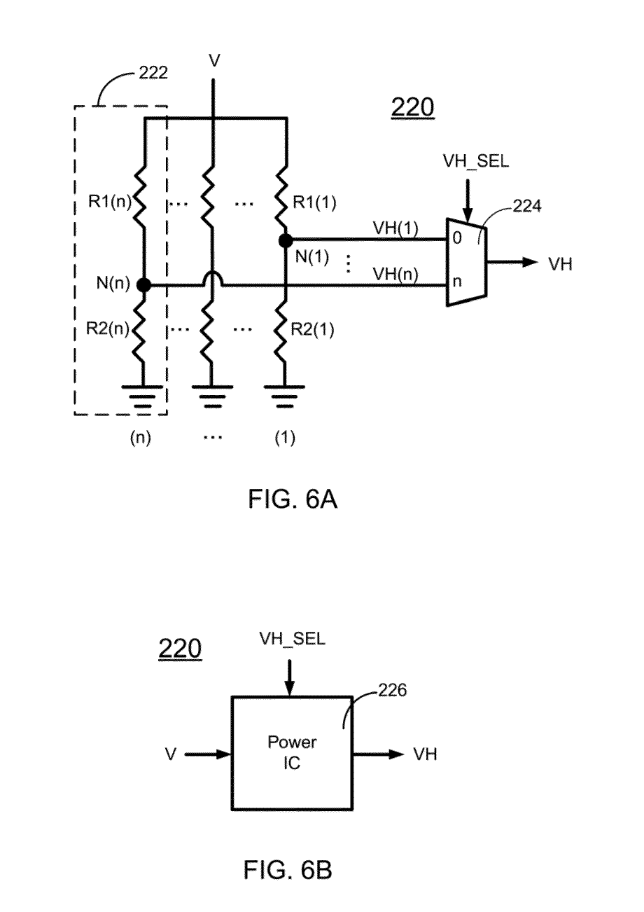

FIG. 6A shows an example of the voltage adjustment circuit 220, which is realized by electrical elements such as resistances and multiplexers. It should be appreciated that the implementation as shown in FIG. 6A is an exemplary embodiment of the voltage adjustment circuit 220, and various hardware or software implementations may be provided for each elements of the voltage adjustment circuit 220. As shown in FIG. 6A, the voltage adjustment circuit 220 includes a plurality of resistor dividers 222 and a voltage selector 224. The resistor dividers 222 are parallely connected to the power circuit 210 (not shown in FIG. 6A), and each of the resistor dividers 222 is labeled from right to left of FIG. 6A as (1) to (n). The voltage selector 224 is electrically connected to the nodes of the resistor dividers 222 and the noise detection circuit 230 (not shown in FIG. 6A).

Each resistor divider 222 is formed by two resistances, including a first resistance R1 and a second resistance R2 connected in series, and defining a node N therebetween. For example, in the first resistor divider 222 labeled as (1), the first resistance R1(1) is connected to the power circuit 210 and the second resistance R2(1) is grounded, defining a node N(1) between the first and second resistances. Thus, for each resistor divider 222 labeled (x), where x is an integer between 1 and n, the resistor divider 222 receives the fixed power voltage V from the power source 210, and divides the fixed power voltage V to generate the voltage signal VH(x) at the node N(x). The relationship between the voltage signal VH(x) obtained by the resistor divider (x) and the fixed power voltage V is:

$$VH ( x ) = \frac{R 2 ( x )}{R 1 ( x ) + R 2 ( x )} \times V \qquad ( 1 )$$

By adjusting the resistance ratio between the first resistance R1 and the second resistance R2 of each resistor divider 222 such that each resistor divider 222 has a different resistance ratio, the resistor dividers 222 may generate a plurality of different voltage signals VH(1), VH(2), . . . , VH(n) at the nodes N(1), N(2), . . . , N(n).

The voltage selector 224 is a data selector or a multiplexer, which receives the voltage signals VH(1), VH(2), . . . , VH(n) from the nodes N(1), N(2), . . . , N(n) of the resistor dividers 222 as the input signals, and the noise selection signal VH_SEL from the noise detection circuit 230 serves as the selection signal for the voltage selector 224. Thus, the voltage selector 224 selects, according to the noise selection signal VH_SEL, one of the voltage signals VH(1), VH(2), . . . , VH(n) as the adjusting voltage VH for the level shift 150.

FIG. 6B shows another example of the voltage adjustment circuit 220, which is realized by a power integrated circuit (IC) 226. The power IC 226 may include a voltage signal table storing the voltage signals VH(1), VH(2), . . . , VH(n) therein, such that in receiving the power voltage V from the power source 210 and the noise selection signal VH_SEL from the noise detection circuit 230, the power IC 226 looks up the voltage signal table for according to the noise selection signal VH_SEL, and selects, according to the noise selection signal VH_SEL, one of the voltage signals VH(1), VH(2), . . . , VH(n) as the adjusting voltage VH for the level shift 150.

Referring back to FIG. 5, the noise detection circuit 230 is electrically connected to the voltage adjustment circuit 220, configured to generate the noise selection signal VH_SEL according to a plurality of sensing signals RX generated by the capacitance touch panel. Specifically, the noise selection signal VH_SEL is determined by the type of noise in the sensing signals RX.

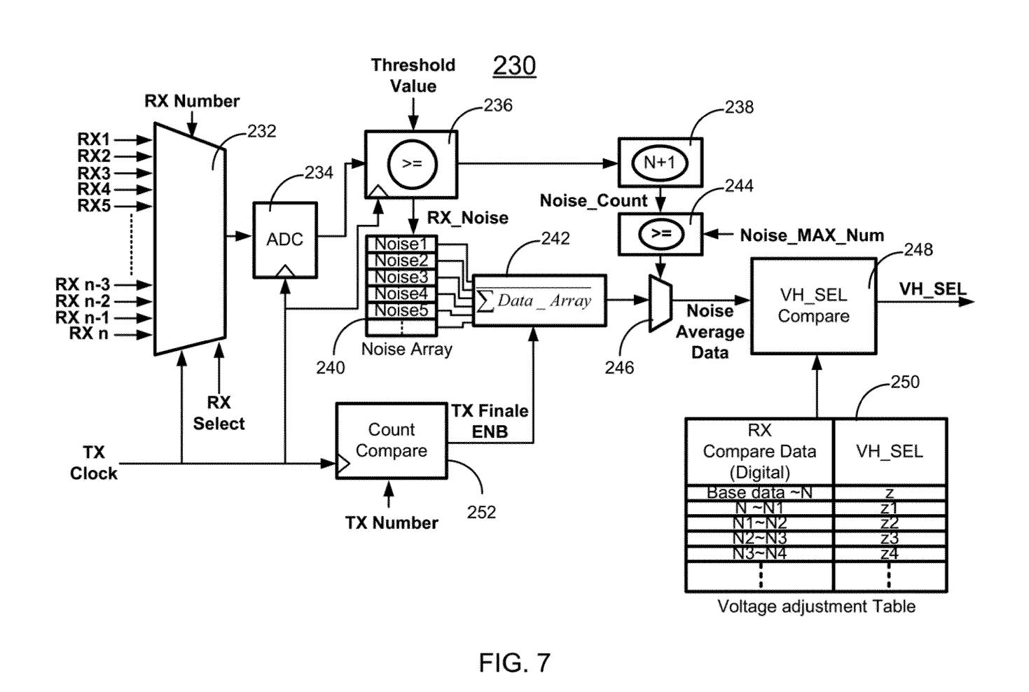

FIG. 7 shows an example of the noise detection circuit 230, which includes multiple electrical hardware circuits and software elements. It should be appreciated that the implementation as shown in FIG. 7 is an exemplary embodiment of the noise detection circuit 230, and various hardware or software implementations may be provided for each elements of the noise detection circuit 230. As shown in FIG. 7, the noise detection circuit 230 includes a sensing selector 232, an analog-to-digital converter (ADC) 234, a threshold comparing circuit 236, a counter 238, a noise array 240, an adder 242, an adder 242, a noise count comparing circuit 244, an averaging circuit 246, a noise selection circuit 248, a voltage adjustment table 250, and a count comparing circuit 252.

Referring back to FIGS. 1 and 4, in operation, the TPIC 120 sends out a plurality of the driving voltages as the pre-adjustment scanning signals to the level shift 150, and the level shift 150 shifts or augments the driving voltages by the adjusting voltage VH to generate the adjusted scanning signals TX for the capacitance touch panel 110. In one embodiment, the TPIC 120 may send out the driving voltages as the pre-adjustment scanning signals in a cycle, which has a period of N frames of the touch sensing, where N is a positive integer. When the capacitance touch panel 110 receives the adjusted scanning signals TX through the scanning lines 112, the sensing lines 114 generate a plurality of sensing signals RX corresponding to each scanning signal TX provided by the signal lines in the column direction, and sends the sensing signals RX back to the TPIC 120 for determination as to whether the touch event occurs. The TPIC 120 then forward the sensing signals RX to the sensing selector 232 of the noise detection circuit 230.

The sensing selector 232 is a data selector or a multiplexer, which is configured to receive the sensing signals RX from the TPIC 120 as the input signals, and the clock signal for the driving voltage TX, the number of the sensing signals RX, and a selection of the sensing signals RX as the selection signals. Thus, the sensing selector 232 selects one of the sensing signals RX for output to the ADC 234 such that the ADC 234 converts the output sensing signal RX to a digital value.

The threshold comparing circuit 236 compares the digital value of the sensing signal RX, which is generated by the ADC 234, to a predetermined threshold value. When the digital value is less than the threshold value, the digital value is determined as a regular data, and the threshold comparing circuit 236 does nothing. On the other hand, when the digital value is greater than or equals to the threshold value, the digital value is determined as a noise data RX_Noise. Thus, the threshold comparing circuit 236 sends a signal to the counter 238, which records a noise count number, such that the counter 238 adds the noise count by 1 to indicate the noise data. The threshold comparing circuit 236 also sends the noise data RX_Noise to the noise array 240, which is a database for the noise data, to store the noise data RX_Noise in the noise array 240.

When all of the sensing signals RX corresponding to one driving voltage TX has been processed, a plurality of the sensing signals RX corresponding to the next driving voltage TX is sent to the sensing selector 232 for determination of the noise data. The process continues until all data related to all of the driving voltages TX in a cycle have been processed. At the end of the cycle, the count comparing circuit 252 sends a signal TX_Finale to the adder 242, indicating that the cycle has ended. Thus, the adder 242 sums up the noise data stored in the noise array 240, and sends the sum to the averaging circuit 246. Then, the noise count comparing circuit 244 compares the noise count number recorded in the counter 238 to a predetermined noise maximum number Noise_MAXNUM. When the noise count number is greater than or equals to the predetermined noise maximum number Noise_MAXNUM, the noise count comparing circuit 244 sends the noise count number to the averaging circuit 246 to calculate and generate a noise average data. Specifically, a noise average data is stored in the averaging circuit 246, and the new generated noise average data replaces the old noise average data. On the other hand, when the noise count number is less than the predetermined noise maximum number Noise_MAXNUM, the noise count comparing circuit 244 does not sends the noise count number to the averaging circuit 246, and the averaging circuit 246 does not update the noise average data.

The noise selection circuit 248 receives the noise average data from the averaging circuit 246, and generates the noise selection signal VH_SEL by looking up the noise average data in the voltage adjustment table 250. The voltage adjustment table 250 is a look-up table recording a plurality of RX comparing data, which corresponds to the different ranges of the noise average data, and corresponding noise selection signals VH_SEL. Thus, by looking up the voltage adjustment table 250 with the noise average data, the noise selection signal VH_SEL may be obtained for output to the voltage adjustment circuit 220.

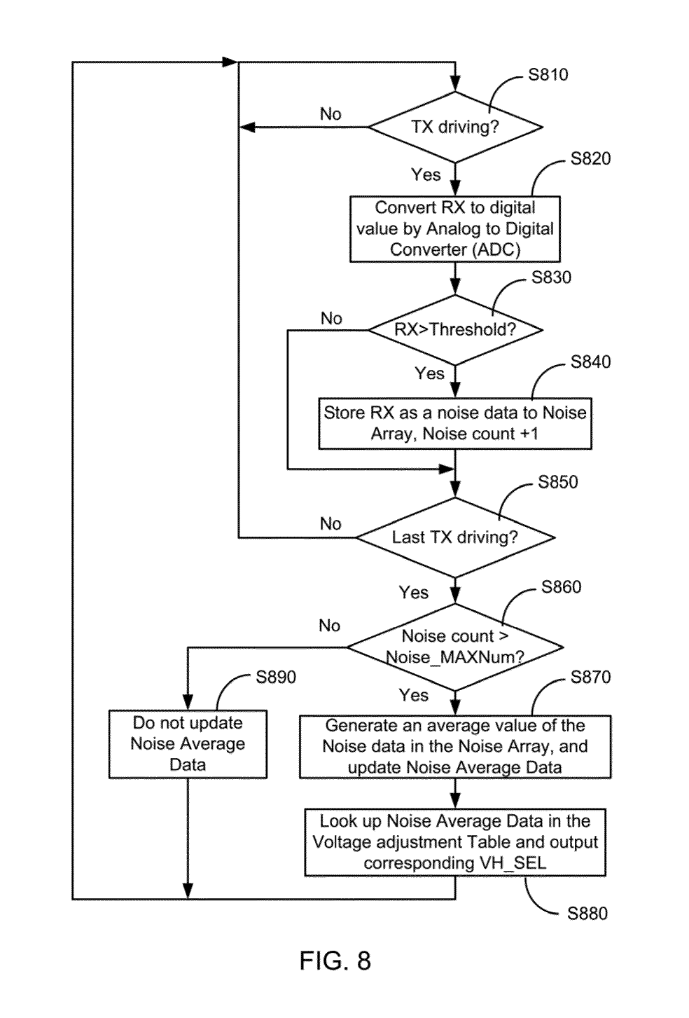

FIG. 8 is a flowchart of the noise detection, which corresponds to the noise detection circuit 230 as shown in FIG. 7. At procedure 5810, at the start of a cycle of the driving voltage, a TX clock signal would be generated and sent to the sensing selector 232 to indicate the TX driving is on. Thus, at procedure 5820, the sensing selector 232 selects a sensing signal RX, and the ADC 234 converts the sensing signal RX to a digital value. At procedure 5830, the threshold comparing circuit 236 compares the digital value of the sensing signal RX to the predetermined threshold value. When the digital value is less than the threshold value, the threshold comparing circuit 236 does nothing. When the digital value is greater than or equals to the threshold value, the threshold comparing circuit 236 stores the digital value of the sensing signal RX as a noise data to the noise array 240, and sends a signal to the counter 238 such that the noise count number is added by 1. The process continues until all data related to all of the driving voltages TX in a cycle have been processed. At procedure 5850, when the circuit determines that the last TX driving has been performed, the noise count comparing circuit 244 compares the noise count number recorded in the counter 238 to a predetermined noise maximum number Noise_MAXNUM. When the noise count number is greater than or equals to the predetermined noise maximum number Noise_MAXNUM, the noise count comparing circuit 244 sends the noise count number to the averaging circuit 246 to calculate and generate a noise average data. Specifically, at procedure 5870, the new generated noise average data replaces the old noise average data. Then, at procedure 5880, the noise selection circuit 248 receives the noise average data from the averaging circuit 246, and generates the noise selection signal VH_SEL by looking up the noise average data in the voltage adjustment table 250. On the other hand, when the noise count number is less than the predetermined noise maximum number Noise_MAXNUM, the noise count comparing circuit 244 does not sends the noise count number to the averaging circuit 246, and at procedure 5890, the averaging circuit 246 does not update the noise average data.

In sum, the invention, among other things, recites methods and systems that utilize dynamic power adjustment of level shift to achieve noise rejection in a capacitance touch system. It should be appreciated that elements of the systems may be realized in the forms of hardware circuit or software elements, or a combination thereof.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A dynamic power adjustment circuit for noise rejection in a capacitance touch system, comprising:
a power source configured to generate a fixed power voltage V;
a voltage adjustment circuit electrically connected to the power source, configured to generate a plurality of different voltage signals VH(1), VH(2), . . . , VH(n) from the power voltage V, to select one of the voltage signals VH(1), VH(2), . . . , VH(n) as a variable adjusting voltage VH according to a noise selection signal VH_SEL, and to output the adjusting voltage VH to a level shift for adjusting a driving voltage, wherein n is an integer larger than 1; and
a noise detection circuit electrically connected to the voltage adjustment circuit, configured to generate the noise selection signal VH_SEL for the voltage adjustment circuit according to a plurality of sensing signals RX generated by a capacitance touch sensing device of the capacitance touch system.

2. The dynamic power adjustment circuit of claim 1, wherein the voltage adjustment circuit comprises:
a plurality of resistor dividers parallely connected to the power source, each resistor divider comprising a first resistance R1 and a second resistance R2 connected in series, wherein the first resistance R1 is connected to the power circuit and the second resistance R2 is grounded, defining a node between the first and second resistances, such that each resistor divider divides the power voltage V to generate one of the voltage signals VH(1), VH(2), . . . , VH(n) at the node; and
a voltage selector electrically connected to the nodes of the resistor dividers and the noise detection circuit such that the voltage selector receives the voltage signals VH(1), VH(2), . . . , VH(n) and determines one of the voltage signals VH(1), VH(2), . . . , VH(n) as the adjusting voltage VH according to the noise selection signal VH_SEL.

3. The dynamic power adjustment circuit of claim 2, wherein for each resistor divider, the voltage signal
$$VH ( x ) = \frac{R 2 ( x )}{R 1 ( x ) + R 2 ( x )} \times V ,$$
wherein x is an integer between 1 and n.

4. The dynamic power adjustment circuit of claim 1, wherein the voltage adjustment circuit comprises a power integrated circuit (IC).

5. The dynamic power adjustment circuit of claim 1, wherein the noise detection circuit comprises:
a sensing selector configured to receive the sensing signals RX and select one sensing signal RX for output;
an analog-to-digital converter (ADC) configured to convert the output sensing signal RX to a digital value;
a comparing circuit comparing the digital value of the sensing signal RX to a threshold value, and storing the digital value as a noise data in a noise array when the digital value is greater than or equals to the threshold value;
an average circuit averaging the noise data in the noise array to generate a noise average data when a number of the noise data in the noise array is greater than or equals to a predetermined noise maximum number Noise_MAX; and
a noise selection circuit configured to generate the noise selection signal VH_SEL by looking up a noise average data of the noise array in a voltage adjustment table.

6. A driving system for a touch display having a capacitance touch sensing device for sensing a touch event, comprising:
a touch sensing controller configured to output a plurality of driving voltages and to receive a plurality of sensing signals RX from the capacitance touch sensing device, and to determine whether the touch event occurs by comparing each sensing signal RX to a threshold value;
a level shift configured to receive the driving voltages and a variable adjusting voltage VH and to send a plurality of scanning signals TX to the touch sensing device, wherein the level shift generates the scanning signals by shifting voltage levels of the driving voltages with the adjusting voltage VH; and
a dynamic power adjustment circuit configured to receive the plurality of sensing signals RX from the touch sensing controller, and to generate the adjusting voltage VH according to noise detection of the plurality of sensing signals RX.

7. The driving system of claim 6, wherein the touch display further comprises a display device for displaying an image characterized with a series of frames.

8. The driving system of claim 7, further comprising:
a display driving controller synchronized with the capacitance touch sensing controller.

9. The driving system of claim 7, wherein the display device and the touch sensing device are integrated into a single in-cell touch display panel or stacked up in separate panels.

10. The driving system of claim 6, wherein the dynamic power adjustment circuit comprises:
a power source configured to generate a fixed power voltage V;
a voltage adjustment circuit electrically connected to the power source, configured to generate a plurality of different voltage signals VH(1), VH(2), . . . , VH(n) from the power voltage V, to select one of the voltage signals VH(1), VH(2), . . . , VH(n) as the adjusting voltage VH according to a noise selection signal VH_SEL, and to output the adjusting voltage VH to the level shift for adjusting the driving voltages, wherein n is an integer larger than 1; and
a noise detection circuit electrically connected to the voltage adjustment circuit and the touch sensing controller, configured to receive the plurality of sensing signals RX from the touch sensing controller, and to generate the noise selection signal VH_SEL for the voltage adjustment circuit according to the plurality of sensing signals RX.

11. The driving system of claim 10, wherein the voltage adjustment circuit comprises:
a plurality of resistor dividers parallely connected to the power source, each resistor divider comprising a first resistance R1 and a second resistance R2 connected in series, wherein the first resistance R1 is connected to the power circuit and the second resistance R2 is grounded, defining a node between the first and second resistances, such that each resistor divider divides the power voltage V to generate one of the voltage signals VH(1), VH(2), . . . , VH(n) at the node; and
a voltage selector electrically connected to the nodes of the resistor dividers and the noise detection circuit such that the voltage selector receives the voltage signals VH(1), VH(2), . . . , VH(n) and determines one of the voltage signals VH(1), VH(2), . . . , VH(n) as the adjusting voltage VH according to the noise selection signal VH_SEL.

12. The driving system of claim 11, wherein for each resistor divider, the voltage signal
$$VH ( x ) = \frac{R 2 ( x )}{R 1 ( x ) + R 2 ( x )} \times V ,$$
wherein x is an integer between 1 and n.

13. The driving system of claim 10, wherein the voltage adjustment circuit comprises a power integrated circuit (IC).

14. The driving system of claim 10, wherein the noise detection circuit comprises:
a sensing selector configured to receive the sensing signals RX and select one sensing signal RX for output;
an analog-to-digital converter (ADC) configured to convert the output sensing signal RX to a digital value;
a comparing circuit comparing the digital value of the sensing signal RX to a threshold value, and storing the digital value as a noise data in a noise array when the digital value is greater than or equals to the threshold value;
an average circuit averaging the noise data in the noise array to generate a noise average data when a number of the noise data in the noise array is greater than or equals to a predetermined noise maximum number Noise_MAX; and
a noise selection circuit configured to generate the noise selection signal VH_SEL by looking up a noise average data of the noise array in a voltage adjustment table.

15. A method for driving a touch display for sensing a touch event, comprising:
receiving a plurality of sensing signals RX from a capacitance touch sensing device of the touch display;
generating a variable adjusting voltage VH according to noise detection of the plurality of sensing signals RX;
generating a plurality of scanning signals TX according to a plurality of driving voltages and the adjusting voltage VH; and
driving the capacitance touch sensing device by the plurality of scanning signals TX.

16. The method of claim 15, wherein the step of generating the plurality of scanning signals TX comprises:
generating, by a touch sensing controller, the plurality of driving voltages; and
adjusting, by a level shift, the plurality of driving voltages by the adjusting voltage VH to generate the plurality of scanning signals TX.

17. The method of claim 15, wherein the step of generating the adjusting voltage comprises:
generating a plurality of voltage signals VH(1), VH(2), . . . , VH(n) from a fixed power voltage V;
generating a noise selection signal VH_SEL according to the plurality of sensing signals RX; and
selecting one of the voltage signals VH(1), VH(2), . . . , VH(n) as the adjusting voltage VH according to the noise selection signal VH_SEL.

18. The method of claim 17, wherein each of the plurality of voltage signals VH(1), VH(2), . . . , VH(n) is generated by providing the power voltage V with a plurality of resistor dividers in parallel to one another, wherein each resistor divider comprises a first resistance R1 and a second resistance R2 connected in series, wherein the first resistance R1 is provided with the power voltage V and the second resistance R2 is grounded, defining a node between the first and second resistances, such that each resistor divider divides the power voltage V to generate one of the voltage signals VH(1), VH(2), . . . , VH(n) at the node.

19. The method of claim 18, wherein for each resistor divider, the voltage signal
$$VH ( x ) = \frac{R 2 ( x )}{R 1 ( x ) + R 2 ( x )} \times V ,$$
wherein x is an integer between 1 and n.

20. The method of claim 17, wherein the step of generating the noise selection signal VH_SEL comprises:
converting each sensing voltage RX to a digital value;
comparing the digital value of each sensing voltage RX to a threshold value, and storing the digital value as a noise data in a noise array when the digital value is greater than or equals to the threshold value;
averaging the noise data in the noise array to generate a noise average data when a number of the noise data in the noise array is greater than or equals to a predetermined noise maximum number Noise_MAXNUM; and
generating the noise selection signal VH_SEL by looking up the noise average data of the noise array in a voltage adjustment table.
